(19) United States
(12) Patent Application Publication
(10) Pub. No.: US 2007/0174082 A1
(43) Pub. Date: Jul. 26, 2007

(54) Payment authorization using location data

(75) Inventor: Moneet Singh, Conshohocken, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Sapphire Mobile Systems, Inc.

(21) Appl. No.: 11/638,296

(22) Filed: Dec. 12, 2006

Related U.S. Application Data
(60) Provisional application No. 60/749,457, filed on Dec. 12, 2005.

(51) Int. Cl. G06Q 99/00

(52) U.S. Cl. 705/1

(57) ABSTRACT

Systems and methods are provided for payment authorization using location data. In an illustrative implementation, a payment authorization platform comprises a location score based authorization engine and at least one instruction set. In the illustrative implementation, the instruction set comprises one or more instructions to instruct the location score based authorization engine to process m-commerce payment transactions according to a selected one or more payment authorization paradigms. The selected one or more payment authorization paradigms can include but is not limited to a fraud detection processing using location scoring principles. Responsive to a payment processing request, the location score based authorization engine generates a location score providing a confidence value. In the illustrative operation, the location score can be calculated by monitoring the pattern of use and the location of mobile transactions and other communications from the mobile communications device.

This non-provisional patent application claims priority to and the benefit of U.S. provisional patent application 60/749,457, filed on Dec. 12, 2005, entitled, “METHOD AND SYSTEM FOR AUTHORIZING PAYMENT AND OTHER TRANSACTIONS BASED ON ACTIVITY AND LOCATION DATA CAPTURED FROM MOBILE DEVICES AND BASE STATIONS OR GPS,” which is herein incorporated by reference in its entirety.

### BACKGROUND

Although there are various solutions that allow for a mobile phone to be used as a payment device, mobile payments and mobile commerce (“m-commerce”) have not been adopted on a wide scale. Various markets, including the United States, are gearing up for the wide-scale deployment and use of this payment media. Specifically, the financial industry, including banks and issuers of credit cards, are building and deploying infrastructure and services to accommodate for expected growth projections.

Payment transaction processing, like other electronic data processing platforms are prone to significant fraud. Such fraud can wreak havoc on the operators and users of such platforms, often compromising private/confidential information and promoting a lack of confidence by the users whose transaction fees support the platform. Additionally, such fraud is costly as cooperating parties (e.g., banks, card issuers, etc.) are left paying the bill (e.g., through fraud protection insurance policies) when fraudulent transactions occur. Although, there are various fraud detection mechanisms in place, such mechanisms lack reliability and application for m-commerce type payment transactions.

With state of the art fraud detection systems, data points are used to “score” transactions according to the probability that they may be fraudulent. For example, if a user who typically purchases only food with a credit card in $20 amounts suddenly purchases a $5,000 some entertainment system, the fraud detection systems will flag the transaction as potentially fraudulent. Based on other factors, such as the user's payment history or income, the probability score will be higher or lower.

Current fraud detection systems rely solely on usage information related to transaction activity. Such systems typically can get information only on the location of the payee (typically a merchant) but cannot simultaneously get the location of the payer. This means that if a credit card is stolen and used at a merchant location, current systems cannot validate the real user's location unless another transaction has been made in a reasonably recent timeframe.

The adoption of the mobile phone as a payments platform will allow telecommunications carrier and financial institutions to expand on anti-fraud and transaction monitoring systems. In this context a user can use the phone not only for payment (e.g., akin to a credit/debit card), but also for communications and data access. Generally, with current practices, a user will use a mobile phone more frequently than a debit/credit car. While a person may use their card once a day, they may use their mobile phone dozens of times in the same time period: to make calls, send text messages, upload photos, and access the Internet. A user's “pattern of mobile phone use” may become a new data source for anti-fraud solutions. Such anti-fraud mechanisms can build on this pattern of use in conjunction with a user's mobile commerce transactions (m-commerce), including mobile payment transactions, to ascertain whether a user's m-commerce transactions are potentially fraudulent. Such an anti-fraud solution, as implemented in an m-commerce setting, can utilize voice and/or data network information.

It is appreciated that there exists a need to overcome the shortcomings of existing practices to provide payment authorization (e.g., fraud detection) using location information of mobile network users.

### SUMMARY

Systems and methods are provided for payment authorization used in m-commerce transactions. In an illustrative implementation, a payment authorization platform comprises a location score based authorization engine and at least one instruction set. In the illustrative implementation, the instruction set comprises one or more instructions to instruct the location score based authorization engine to process m-commerce payment transactions according to a selected one or more payment authorization paradigms. The selected one or more payment authorization paradigms can include but is not limited to a fraud detection processing using location scoring principles.

In an illustrative operation, data is received by the location score based authorization engine representative of a user and a payment processing request. Responsive to the payment processing request, the location score based authorization engine generates a location score. In the illustrative operation, the location score can be calculated by monitoring the pattern of use and the location of mobile transactions and other communications from the mobile communications device. In the illustrative implementation, a location score can reflect the probability that a given mobile transaction is fraudulent

Other features of the herein described system and methods are further described below.

### BRIEF DESCRIPTION OF THE DRAWINGS

Referring now to the figures, in which like reference numbers refer to like elements throughout the various drawings that comprise the figures. Included in the figures are the following:

FIG. 1 is a block diagram of an exemplary payment authorization environment employing location scoring in accordance with the in accordance with the herein described systems and methods;

FIG. 2 is a block diagram of exemplary data flow between cooperating components of an exemplary payment authorization environment in accordance with the herein described systems and methods;

FIG. 3A is a block diagram of the operation of cooperating components of an exemplary payment authorization environment in accordance with the herein described systems and methods;

FIG. 3B is a block diagram of the other operation of cooperating components of an exemplary payment authorization environment in accordance with the herein described systems and methods;

FIG. 3C is a block diagram of the other operation of cooperating components of an exemplary payment authorization environment in accordance with the herein described systems and methods;; and

FIG. 4 is a flow diagram of the processing performed when performing location based payment authorization in accordance with the herein described system and methods.

### DETAILED DESCRIPTION

Exemplary Location Scoring Authorization Environment

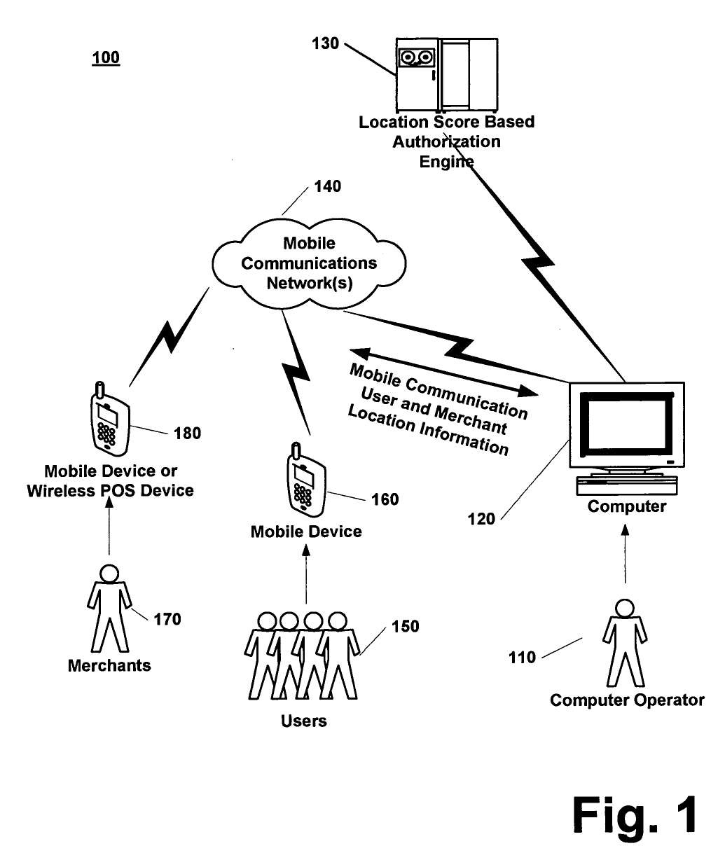

FIG. 1 illustrates an exemplary payment authorization environment 100 employing location scoring principles, which, as is shown, comprises computer operator 110, computing environment 120, location score bases authorization engine 130, mobile communications network(s) 140, users 150 of the mobile communications network(s) and their mobile communications devices or phones 170, and merchants 160 which provide m-commerce functionality via their mobile phones or wireless capable point of sale (POS) devices 180.

In an illustrative operation, users 150 of an m-commerce system implementing the herein described system and methods interact with other users 150 or with merchants 170 using their mobile devices 160 and wireless capable POS devices 180. In the illustrative operation, users 150 can engage in m-commerce transactions with other users 150 or with merchants 170. Illustratively, the location and time data pertaining to the location of the users 150 and merchants 170 involved in the m-commerce transaction(s) and the time of the transaction(s) can be delivered from the mobile communications network 140 to the computing environment 120. Computing environment can then operate to pass the data to location score based authorization engine 130. Location score based authorization engine 130 then ca calculate a location score for the transaction based upon the location and time data pertaining to the m-commerce transaction(s). If the location score is of a value which may indicate fraud is involved in the m-commerce transaction(s), location score based authorization engine 130 will instruct the computing environment 120 to either flag the m-commerce transaction(s) as possibly fraudulent or to prevent the m-commerce transactions from proceeding.

It is appreciated that although the exemplary payment authorization environment 100 is described to employ specific components having a particular configuration that such description is merely illustrative as the inventive concepts described herein can be performed by various components in various configurations. For example, although a computing environment 120 and location score based authorization engine 130 are described to be separate in FIG. 1, such description is merely illustrative as these two computing environments can exist in a single computing environment. Furthermore, the computing environment 120 and location based authorization engine 130 may exist as part of an m-commerce system operated by a firm distinct from the mobile communications networks, or may exist as integrated into the information technology systems of the mobile communications networks. Although this disclosure describes the use of the method and system as applied to a mobile payments system, those skilled in the art may apply the method and system to other types of payments systems and networks.

Illustrative “Location Scoring” Process

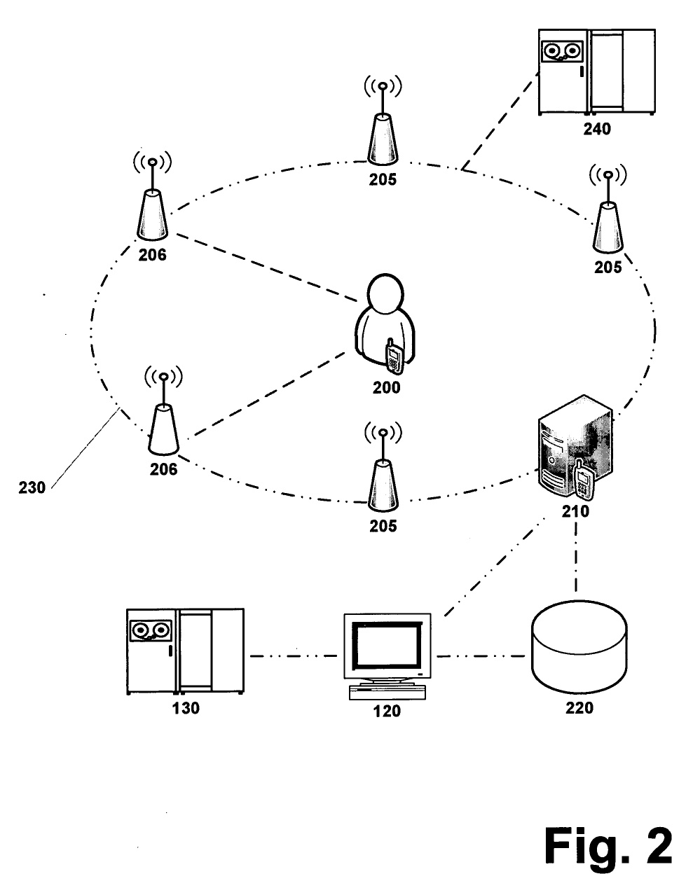

It is appreciated that an exemplary payment authorization environment 100 of FIG. 1 can maintain various operations and features. FIG. 2 provides an illustrative implementation of the cooperation of exemplary components of payment authorization environment 100 of FIG. 1.

As is shown in FIG. 2, user 200 can cooperate with mobile communications network 230 and/or m-commerce system 240 which is either part of the mobile communications network 230 or uses the mobile communications network 230 (as indicated by the dashed lines). Mobile communications network 230 can comprise a number of base stations or cellular towers 205, 206 which can operate to transmit and receive the wireless signals to/from the mobile phones. Further, mobile communications network 230 can be managed by computer system 210. In an illustrative operation, computer system 210 can use data storage system 220 to store data pertaining to various calls made using mobile communications network 230. Exemplary data that can be stored by computer system 210 include but are not limited to time/duration of mobile telephony calls, the identity of the recipient of mobile telephone calls, the identity of the parties with whom are engaging in m-commerce transactions, etc.

Although a user 200 can interact with any base station tower which belongs to a mobile communications network, a user will generally interact with a limited number of base station towers 206 that are generally located within a selected geographic area in which a user most often interacts with the mobile communications network. Generally, user 200 can interact with the same base station towers 206 in given areas, such as on a commute, while at home, while at work, etc., since these towers are in fixed or known locations in the various cells across a mobile communications network. In the illustrative operation, computer system 210 can operate to retain this data pertaining to when and to which base station(s) user 200 connects (essentially the user's pattern of use of the mobile communications network) and can store such data in a data storage system 220. In an illustrative implementation, computer system 210 can further comprise computing environment 120 (of FIG. 1) and location score based authorization engine 130. In another illustrative implementation, computing environment 120 and/or location score based authorization engine may reside separately from computer system 210 which manages the mobile communications network.

User 200, of a mobile communications device enabled to make/receive mobile payments, can use an exemplary mobile communications device (not shown) to make purchases (or receive payments if the user is a merchant) in known or fixed locations (such as the user's neighborhood grocery store). In this illustrative operation, a user 200 can engage in a “person-to-person” funds transfer with another mobile payment device user. In such illustration, the transaction can take place in the radius of a set of given base stations 206. The location information related to the parties involved in the mobile system payment transaction can also be logged and tracked by computer system 210.

Based on the data derived from the pattern of use and the location of both mobile transactions and other communications from the mobile communications device, computing environment 120 and location score based authorization engine 130 can calculate a location score which reflects the probability that a given mobile transaction is fraudulent. For example, assume user 200 has a pattern of phone use and payment in which the user is monitored to communicate to a regular set of base stations 206. However, if a payment is made in the radius of a base station 205 which, as the stored location information indicates, never or infrequently is visited by user 200, then this transaction can be associated with a location score indicative of a higher probability of fraud. In an embodiment of the invention, computing environment 120 can use location score in combination with other state of the art fraud detection systems to calculate a final probability of fraud for a mobile payment transaction.

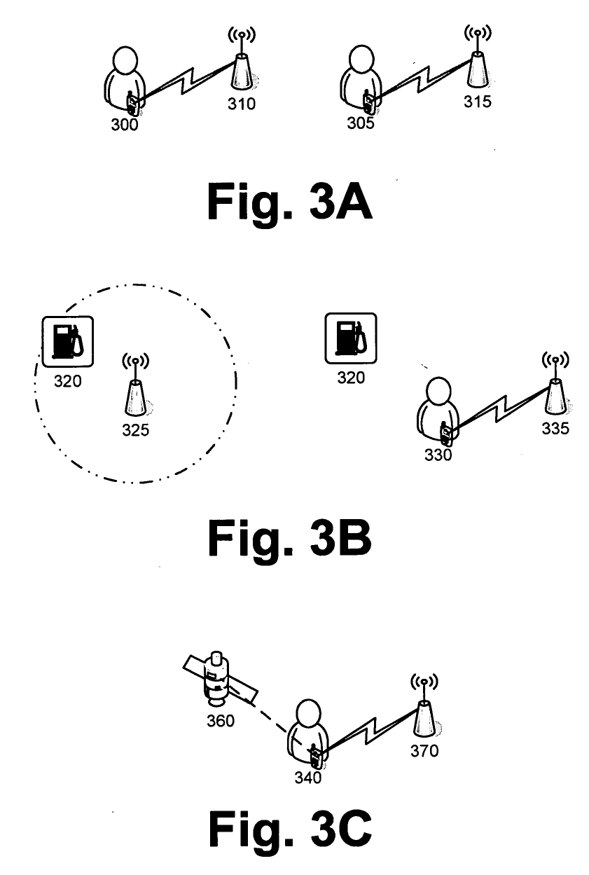

FIGS. 3A, 3B and 3C, with reference to components of FIG. 1, provide illustrative implementations of the herein described systems and methods. As is shown in FIG. 3A, user 300 can interact with base station 310 in one location, such as New York City. Thereafter, a person purporting to be the user 300 (i.e., person 305_can make a mobile payment using a base station 315 in a different location, such as Los Angeles. In an illustrative operation, computing environment 120 can compare the time difference between the user's 300 interaction with the base station 310 in New York and the payment transaction in Los Angeles 315 and then compare this time difference to the average travel time required to reach the radius of the second base station from the first base station. If this average travel time is greater than the time difference between the two transactions, then the payment transaction can receive a high fraud probability and may be flagged or rejected. The base stations involved in this procedure may be as distant as two base stations in two different states or as close as two base stations in different parts of a city.

Similarly, if a phone call is made using the first base station 310, then a payment is made using the second base station 315, and then a payment is made using the first base station 310 within the “critical” time limit, then computing environment 120 can mark the transaction made using the second base station 315 as potentially fraudulent while allowing the transaction made using the first base station 310 to continue. As such the herein described system and methods provide additional certainty to “payment only” data-based decision making used by current fraud detection systems since current solutions do not allow users to easily ascertain if the first or second transaction is more or less likely to be fraudulent (outside other factors such as size, item, etc.).

FIG. 3B illustrates the use of herein described systems and methods in the context of a merchant with a set physical location. A merchant, such as a gas station 320, can be within the coverage area of a certain base station 325. By way of example, if user 330 attempts to make a mobile payment to gas station 320 using a different base station 335 whose coverage area does not include gas station 320, computing environment 120 can operate to give the transaction a location indicative of a higher probability of fraud than if the user 330 had remitted a mobile payment to a base station 325 whose coverage area included the gas station. Computing environment 120 can also adjust the location score with parameters based on knowledge of the merchant's business (i.e., a “mobile merchant” such as a plumber may use several base stations in his work area while a “fixed” merchant such as the gas station may only use one base station).

FIG. 3C depicts an illustrative implementation utilizing global positioning system (GPS) data (if the mobile device is equipped with such functionality) as an addition to the location information corresponding to the data from the base stations used by a user 340. As is shown in FIG. 3C, user 340 can communicate with base station 370 and the user's phone can transmit the user's GPS location as determined according to the global positioning satellites 360. User's 340 GPS data can give a more precise location of the user 340 than simply the identity of the base station 370 used by user 340. In another illustrative implementation of the herein described systems and methods the invention, triangulation principles can be used to more precisely determine the physical location of user 340. Either the additional GPS data or the triangulation data may be used to modify the location for user's 340 transactions as calculated by the computing environment 120.

The herein described system and methods can also be used to provide additional authorization data when performing user validation via personal information number (PIN) based systems, such as those associated with debit cards. For example, as the mobile phone is used as the “PIN terminal” in a mobile device payment system, the herein described systems and methods can use location data pertaining to the user at the time of the user's transaction(s) in addition to the user's PIN. Furthermore, in a mobile device payments system, a message can be sent to the device to request PIN entry; the reply message from the user containing the PIN may be used for ID validation and to concurrently locate the device. The PIN can also be associated with identifiers of the user's specific mobile device. The herein described systems and methods can then use the PIN, in conjunction with the location of the device to determine if the transaction were likely to be fraudulent.

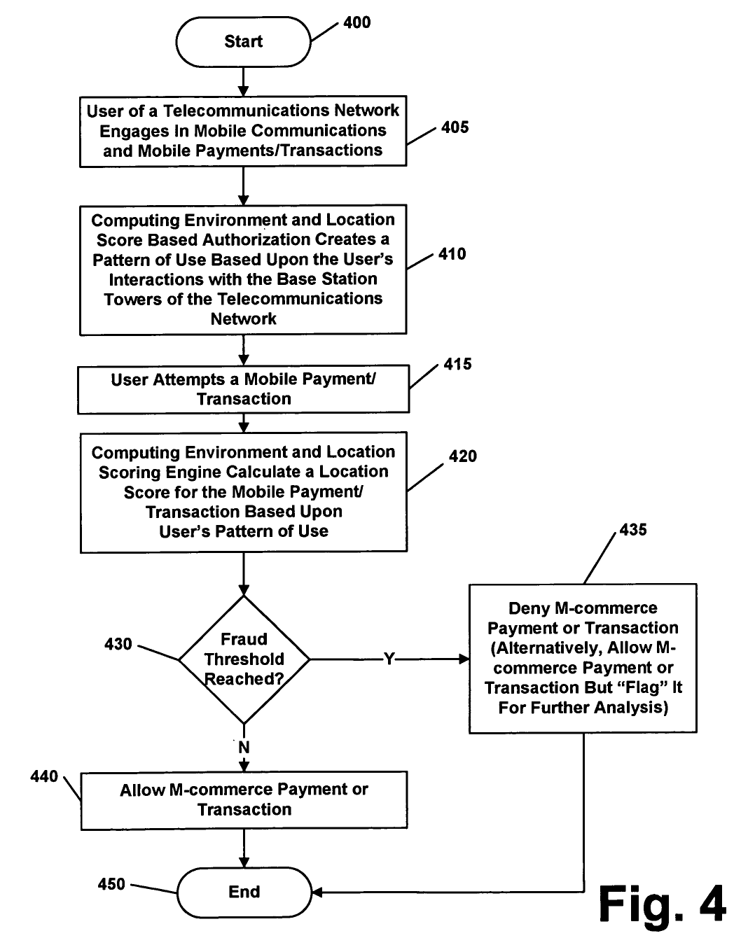

FIG. 4 shows the processing performed when performing payment authorization in which a user can interact with the mobile telecommunications network, thereby establishing a pattern of use, and computing environment 120 and location score based authorization engine 130 calculate a location score in order to evaluate the likelihood that subsequent mobile payments or transactions are fraudulent. As is shown, processing begins at block 400 and proceeds to block 405 where a user of the telecommunications network begins to use the telecommunications network for communications, such as phone calls and text messages, and for mobile payments or other types of mobile commerce transactions. From there, processing proceeds to block 410 where computing environment 120 and location score based authorization engine 130 retain information pertaining to which base stations (e.g. base station 206 of FIG. 2) a user interacts with during the user's communications and mobile payments/transactions. Using this information, computing environment 120 and location score based authorization engine 130 creates a pattern of use based upon the user's communications and mobile payments/transactions at block 410.

After constructing a pattern use, the user can attempts a subsequent mobile payment or mobile commerce transaction at block 415. Computing environment 120 and location score based authorization engine 130 can operate to obtain the information related to the transaction (specifically the time of the attempted transaction and the location of the base stations with which the user is interacting during the attempted transaction) and calculates a location score for the intended transaction at block 420. Computing environment 120 and location score based authorization engine 130 will then compare the calculated “Location Score” (possibly in conjunction with other anti-fraud mechanisms) to determine if the intended transaction's score reaches a predetermined fraud threshold level 430. If the check at block 430 indicates that the intended transaction reaches this predetermined fraud threshold level, then the intended transaction may be denied (since the likelihood of it being a fraudulent payment/transaction is too great) or allowed but flagged for further anti-fraud analysis at block 435. Processing then terminates at block 450.

However, if the intended transaction does not reach the predetermined fraud threshold, then the intended transaction will be allowed at block 440, after which the processing terminates 450.

It is understood that the herein described systems and methods are susceptible to various modifications and alternative constructions. There is no intention to limit the herein described system and methods to the specific constructions described herein. On the contrary, the invention is intended to cover all modifications, alternative constructions, and equivalents falling within the scope and spirit of the herein described system and methods.

It should also be noted that the herein described system and methods may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the herein described system and methods has been described in detail above, those skilled in the art will readily appreciate that many additional modifications are possible in the exemplary embodiments without materially departing from the novel teachings and advantages of the invention. Accordingly, these and all such modifications are intended to be included within the scope of the herein described system and methods. The herein described system and methods may be better defined by the following exemplary claims.

What is claimed is:

1. A system for payment authorization comprising:
a location score based authorization engine; and
an instruction set having at least one instruction to instruct the a location score based authorization engine to generate a location score for use in fraud detection processing and payment authorization,
wherein the location score is calculated using data representative of users interaction with one or more components of a mobile communications network that provides location information,
wherein the data representative of users interaction comprises data representative one or more: time of interactivity, frequency of interactivity, type of interactivity, and data about other cooperating users.

2. The system as recited in claim 1 further comprising a communications network operable to communicate data to and from the location score based authorization engine.

3. The system as recited in claim 2 further comprising a mobile device cooperating with the location score based authorization engine using the communications network.

4. The system as recited in claim 3 further comprising a management computing environment cooperating with the location score based authorization engine to store data representative of user location information as the user interacts with the mobile communications network.

5. The system as recited in claim 1 wherein the location score based authorization scoring engine comprises a computing environment.

6. The system as recited in claim 5 wherein the location score based authorization scoring engine comprises a computing application operating on a computing environment that cooperates with the management computing environment to generate the location scores.

7. The system as recited in claim 1 further comprising one or more base stations cooperating with the mobile communications network to provide location information about users as they interact with the mobile communications network.

8. The system as recited in claim 1 wherein the location scores are calculated using GPS data which is generated by a cooperating mobile device.

9. The system as recited in claim 1 further comprising mobile devices operable to cooperated with a cooperating mobile communications network which is operatively coupled to the location score based authorization engine.

10. The system as recited in claim 9 wherein the mobile devices interacting with one or more components of the mobile communications network provide data representative of user interactivity and user location over a cooperating mobile communications network to the location score based authorization engine.

11. A method for payment authorization using location data comprising:
receiving data representative of a user's interactivity with other users of a mobile communications network;
constructing a location pattern for the user based on the user's interactions on the mobile communications network; and
processing the interactivity data and user location information to generate a location score.

12. The method as recited in claim 11 further comprising communicating the generated location score to cooperating anti-fraud components for use as part of fraud detection processing.

13. The method as recited in claim 11 further comprising selecting a threshold fraud value representative of a high confidence of fraud.

14. The method as recited in claim 13 further comprising comparing the generated location score with the threshold fraud value to determine if a transaction engaged in over the mobile communications network is fraudulent.

15. The method as recited in claim 11 further comprising generating a high fraud score representative of a low risk of fraud for various interactivity data comprising: base station utilization information, time of transaction, location of base station being utilized, and location of other users.

16. The method as recited in claim 11 further comprising receiving data about other users of the mobile communications network as a basis to calculate a location score.

17. The method as recited in claim 16 further comprising generating the location score relying on the location information about a cooperating merchant.

18. The method as recited in claim 11 further comprising receiving from a cooperating management computing environment data representative of a user's interactivity with other users of a mobile communications network

19. The method as recited in claim 11 further comprising receiving from one or more mobile devices data representative of a user's interactivity with other users of a mobile communications network

20. A computer readable medium having computer readable instructions to instruct a computer to perform a method comprising:
receiving data representative of a user's interactivity with other users of a mobile communications network;
constructing a location pattern for the user based on the user's interactions on the mobile communications network; and
processing the interactivity data and user location information to generate a location score.
